(19) United States
(12) Patent Application Publication
(10) Pub. No.: US 2005/0150323 A1
(43) Pub. Date: Jul. 14, 2005

(54) Composite flywheel rim having commingled layers with macroscopically uniform patterns of fiber arrangement and methods for manufacturing same

(75) Inventor: Ward R. Spears, Essex, MA (US)

Correspondence Address: EDWARDS & ANGELL, LLP, P.O. BOX 55874, BOSTON, MA, 02205, US

(73) Assignee: Beacon Power Corporation

(21) Appl. No.: 11/028,349

(22) Filed: Dec. 30, 2004

Related U.S. Application Data
(63) Continuation of application No. 10/613,984, filed on Jul. 3, 2003, now abandoned.
Application No. 10/613,984 is a continuation-in-part of application No. 09/952,151, filed on Sep. 13, 2001, now Pat. No. 6,852,401.
Application No. 10/613,984 is a continuation-in-part of application No. 09/952,283, filed on Sep. 13, 2001, now Pat. No. 6,824,861.

(51) Int. Cl. G05G 1/00

(52) U.S. Cl. 74/572.21

(57) ABSTRACT

A composite-based rim includes multiple fiber-based, commingled layers wherein the strength and/or stiffness increases from the innermost to the outermost layer of the rim, but wherein the radial stress and strain generated in the rim decreases from the innermost to the outermost layer. At least some layers have a mixture of carbon fiber tows and glass fiber tows. The ratio of carbon fiber tows to glass fiber tows in each layer is constant, and the distribution of carbon fiber tows is macroscopically uniform in each layer.

### CROSS REFERENCE TO RELATED APPLICATIONS

This application claims priority to, incorporates by reference the entirety of, and is being filed as a continuation-in-part of U.S. patent application Ser. No. 09/952,151, which was filed on Sep. 13, 2001, and which is currently pending, and this application also claims priority to, incorporates by reference the entirety of, and is being filed as a continuation-in-part of U.S. patent application Ser. No. 09/952,283, which was filed on Sep. 13, 2001, and which also is currently pending.

### FIELD OF THE INVENTION

The present invention relates generally to composite-based rims, and methods for their manufacture. More particularly, the present invention relates to composite-based rims that are ideally suited for incorporation into flywheel systems because the rims are comprised of a plurality of commingled fiber layers, and more specifically to hybrid composite-based rims that are comprised of a plurality of commingled fiber layers having macroscopically uniform fiber distribution.

### BACKGROUND OF THE INVENTION

Flywheel systems have been known in the art for a number of years, and have proven to be extremely useful in industrial settings (as, for example, uninterruptible power supplies) due to their excellent ability to store and recover kinetic energy. A typical flywheel system includes a flywheel, a shaft to which the flywheel is secured, as well as one or more bearing assemblies that rotatably support the shaft. A flywheel system also includes a protective outer rim, which is supported by a hub that serves to connect the rim to the shaft.

In operation, a high-powered, high-strength motor drives the shaft, which itself drives a rotor at a high velocity. This causes the rim of the flywheel system to rotate/spin rapidly, which, in turn, creates a significant amount of kinetic energy in accordance with the following equation:
Energy=½*(rim density)*(rim volume)*(rotor radius of gyration)²*(rotational speed of rim)²

Since the advent of flywheels, those in this art have constantly aimed to design a flywheel system that is able to generate as much kinetic energy as possible according to this equation without compromising the safe operation of the flywheel system. To that end, several years ago, designers began to experiment with switching from metal-based to composite-based rims.

Metal-based rims had proven problematic in use because their somewhat low yield strength limited their ability to generate rotational speed and, therefore, the ability of the flywheel system to generate significant amounts of kinetic energy. And although metal-based rims had proven highly failure resistant, when they did fail, they tended to break into three large, heavy pieces, which were jettisoned from the flywheel system, thus presenting a danger to surrounding persons and property alike.

Composite-based rims are not only lighter than metal-based rims, but can have comparable or even higher strengths and stiffnesses, thus allowing them to achieve much higher rotational speeds and, therefore, to apparently provide most, if not all of the benefits of metal-based rims, without the aforementioned risks/drawbacks.

Not surprisingly, within just a few years of their discovery, composite based rims had become a widely accepted standard within the flywheel and energy storage system industry.

More recently, however, it has become evident that composite-based rims also can encounter problems in use, chief among which is their susceptibility to failure due to radial stresses and strains that arise during operation of a flywheel system.

As noted above, flywheel systems that incorporate composite-based rims are primarily advantageous as compared to metal-based rims because their lower weight allows them to be able to rotate more rapidly than metal-based rims and, in turn, to generate more energy for storage than would be generated by an otherwise identically dimensioned metal-based rim. But as the speed of rotation of any flywheel system rim (whether metal- or composite-based) increases, so too does the undesirable strain, and hoop/radial stresses placed against it according to the equations:
Hoop Stress=(rim density)*(rim radius)²*(rim rotational speed)²=(hoop strain)* (hoop modulus)
Radial Stress−(rim density)*(rim Thickness)²*(rim rotational speed)²

Thus, for example, according to the second equation, a first rotating rim that is twice as thick as a second rotating rim will have a peak radial stress that is approximately four times greater than that of the second rotating rim. This is a marked increase in the generation of stresses and strains in a composite-based rim, which has a relatively low radial strength as compared to its hoop strength.

Realizing this, but not wanting to sacrifice the benefit(s) of increased rim rotational speed (and, thus, increased kinetic energy), some suggested reducing the thickness of composite-based rims, while increasing the rims' length.

The likely rationale for doing so was the fact that the square of the rim thickness is proportional to the amount of strain and radial stress encountered in the rim, such that a decreased rim thickness should offset enough of the increase in rotational speed of the rim to keep the amount of strain and radial stress encountered in the rim within a manageable range. The length of the rim (which, is a factor of the rim volume, is proportional to the amount of kinetic energy produced by the rim) was increased was to compensate for the reduction in energy that would be caused by reducing the rim's cross sectional area, which is also directly proportional to the amount of kinetic energy generated by the rim.

Unfortunately, flywheel systems that incorporated rims with both reduced thickness and increased lengths proved to be unduly expensive to produce and to implement and operate, and, therefore, quickly grew out of favor in the art.

Therefore, a need remains for a composite-based rim for use in flywheel systems, wherein the design of the rim positively influences the ability of the rim to generate energy without negatively influencing, due to the generation of unmanageable radial stresses and strains, the rim's longevity and the safe operation of a flywheel system within which the rim is incorporated.

### SUMMARY OF THE INVENTION

The present invention features composite-based flywheel system rims comprised of a plurality of commingled fiber layers, as well as methods for manufacturing such rims that meet this and other needs. Although the composite-based rim of the present invention is primarily described as being applicable to flywheel-based evacuated energy storage systems, it may be used in other environments in which stresses and strains are encountered, and are sought to be manageably controlled.

In an exemplary aspect of the present invention, a composite-based rim is comprised of a plurality of tailored, commingled fiber-based layers. The rim should include at least two fiber layers, and may include a plurality of layers up to, or even greater than ten. In a particularly exemplary aspect of the present invention, the rim includes five layers, at least two of which are commingled layers.

As used herein the terms “co-mingled” and “commingled” as used herein shall be understood to mean or describe a fiber arrangement that exhibits a pattern in which there is mingling of non-uniform fibers (e.g., mingling of “low” strength/stiffness fibers such as E-glass and/or “high” strength/stiffness fibers such as carbon) such that each rim layer comprised of the mingled fibers possess uniform properties.

Each rim layer is generally comprised of a different combination of fiber(s) than the other layer(s) such that the rim exhibits increased an strength to density ratio and/or stiffness in each of its successive layers from its innermost layer to its outermost layer.

The rim layers include “low” strength/stiffness fibers and/or “high” strength/stiffness fibers, wherein the volume percentage of “low” strength and/or stiffness fiber(s) contained in each layer successively decreases or remains constant from the innermost rim layer to the outermost rim layer, while the volume percentage of “high” strength and/or stiffness fiber(s) contained in each layer successively increases or remains constant from the innermost layer to the outermost layer.

In a particular aspect of the invention, the rim includes five layers, wherein the volume percentage of “low” strength/stiffness fiber(s) decreases from the first layer of the rim, to the second layer, to the third layer, to the fourth layer, and remains constant in the fourth and fifth layers, but where the volume percentage of “high” strength/stiffness fiber(s) increases from the first layer, to the second layer, to the third layer, to the fourth layer, and remains constant in the fourth and fifth layers.

The specific compositions of the layers of the rim are selected to tailor the strengths and stiffnesses of the rim, and, more particularly, to create a smooth gradient of radial stress and strain from layer to layer.

By varying the composition of the layers, not only are the strength and stiffnesses of those layers varied, so too are their densities and moduli, both of which affect the generation of radial stress an strain on the rim, which, in turn, affect the formation of undesirable cracks within the rim.

Further, by smoothly varying the stiffnesses and densities of the layers, the composite-based rim became, in effect, a radial succession of thin rings spinning together, with the inner rings desirably loading the outer rings in slight radial compression. Conventional composite-based rims do not have compositions that allow them to achieve this type of smooth radial stress and strain gradient, and thus are less resistant to crack formation, and less effective to guard against rim failure than composite-based rims of the present invention.

Moreover, even in the unlikely event that a crack does form in a rim of the present invention, the crack will likely form in the innermost layer of the rim, and will be inhibited from propagating into and through the other four layers of the rim. And even if the crack does manage to propagate, that will cause a flywheel system upset/imbalance condition, which will be sensed and acted upon before the crack has time to propagate through all of the layers of the rim.

Therefore, the above-described technique relating to the composition of a rim in accordance with the present invention represents a design philosophy that deters crack formation in the rim by controlling the stresses encountered within the rim to manageable levels. Further, such a technique, by virtue of the tailored compositions of the layers, causes cracks (if any are formed) to be initially formed in the first layer, and severely inhibits the ability of such cracks to propagate into the second, third, and especially fourth and fifth layers of the rim. This, in turn, allows a flywheel system that incorporates a composite-based rim in accordance with the present invention to be confidently operated at high speeds without fear of adverse effects (i.e., rim failure/burst), thus allowing for the flywheel system to beneficially generate a comparatively large amount of kinetic energy.

In additional aspects of the present invention there is featured a composite flywheel rim having multiple rim layer, more particularly multiple hybrid fiber layers in each of which the mixture ratio of “high” strength/stiffness fibers such as carbon fibers versus “low” strength/stiffness fibers such as E-glass or glass fibers is constant and the ratio incrementally increases layer by layer toward outside of the rim and the distribution of the “high” strength/stiffness fibers or carbon fibers is macroscopically uniform in each layer.

It has been found that more macroscopically uniform fiber distribution may be important to achieve uniform stress distribution during rotor spinning even with the constant mixture ratio between “low” strength/stiffness fibers such as E-glass or glass fibers and/or “high” strength/stiffness fibers such as carbon fibers. It shall be understood hereinafter that reference to carbon fibers shall be understood to include “high” strength/stiffness fibers and the reference to e-glass fiber or glass fiber shall be understood to include “low” strength/stiffness fibers.

The macroscopically uniform distribution can be achieved by controlling the correlation between lead rate of fiber band per mandrel revolution and the winding length. Carbon fiber tow spacing and position in the band, and a width of a carbon fiber tow also affect the lay up pattern, however, the most effective and the easiest way to change the lay up pattern with constant parameters is by controlling the winding length.

The present invention also features other methods for manufacturing a composite-based rim, such as via a filament winding technique. In accordance with an exemplary aspect of this method, fiber tows are stored within, and dispensed from one or more racks/holders within a device (e.g., a creel) and are layered atop each other in predetermined commingled tow arrangements in order to preliminarily form each of the fiber layers of the rim.

This preliminarily formed layer is directed through one or more physical adjustment devices (e.g., one ore more rollers and/or one or more combs) and then into a resin treatment area of the apparatus where a spinning drum is continuously being impregnated with wet resin being held within a holding area (e.g., a resin bath). As the layer advances through the resin treatment area, the resin-coated drum spins in the direction of advancement of the layer, thus causing the bottom-facing side of the fiber layer to be coated (by the drum) with wet resin mixture.

The wet layer is then directed through one or more additional physical adjustment devices (e.g., one or more rollers and/or one or more combs) to produce a uniform, wet layer of fiber material or predetermined bandwidth. Thereafter, the layer is fed through a guiding device (e.g., an eyelet) and caused to be wound onto a shape-instilling shell to form one of the layers of the multiple-layer rim of the flywheel system. Once all the desired layers of the rim have been wound onto the shell, the shell is cured, thus causing the resin on each layer to dry.

In additional aspects, there is featured methods for manufacturing a composite rim as described herein having multiple hybrid fiber rim layers. Such a method includes having the fiber tows being laid in a lay-up pattern that is defined by controlling the correlation between lead rate per mandrel revolution and winding length.

Other aspects and embodiments of the present invention are discussed in detail below.

### BRIEF DESCRIPTION OF THE DRAWINGS

For a fuller understanding of the nature and desired objects of the present invention, reference is made to the following detailed description, which is to be taken in conjunction with the accompanying drawing figures wherein like reference characters denote corresponding parts throughout the several views presented within the drawing figures, and wherein:

FIG. 1A is a schematic view of a composite-based rim in accordance with the present invention;

FIG. 1B is a cross sectional view of the rim of FIG. 1A along the line A-A;

FIG. 2 is a schematic view of an apparatus for manufacturing the FIG. 1 rim;

FIG. 3 is a schematic plan view of a mandrel on which is being wound a band of resin-impregnated fiber tows, illustrating the position of the fiber band at its two extreme end positions;

FIG. 4 is a sectional elevation of the mandrel shown in FIG. 3 after the fiber winding operation has been completed;

FIG. 5 is a sectional diagram of a magnified cross section of composite flywheel rim, cut along a radial plane parallel to the axis of the rim, illustrating an undesirable stacked fiber distribution;

FIG. 6 is a sectional diagram of a magnified cross section of composite flywheel rim, cut along a radial plane parallel to the axis of the rim, illustrating a macroscopically cross hatched fiber distribution; and

FIG. 7 is a sectional diagram of a magnified cross section of composite flywheel rim, cut along a radial plane parallel to the axis of the rim, illustrating a preferred macroscopically random or uniform distribution of carbon fibers amongst the glass fibers.

### DETAILED DESCRIPTION OF THE INVENTION

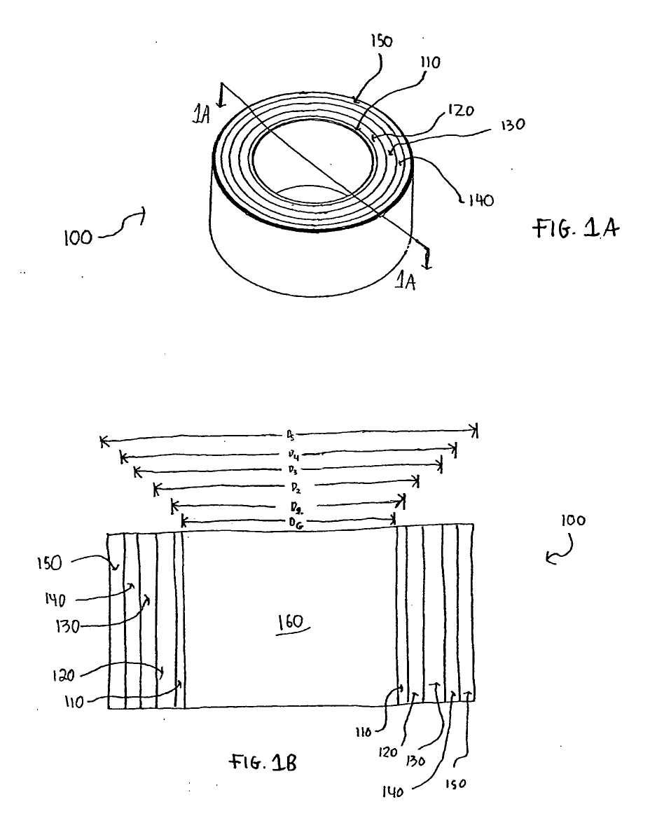

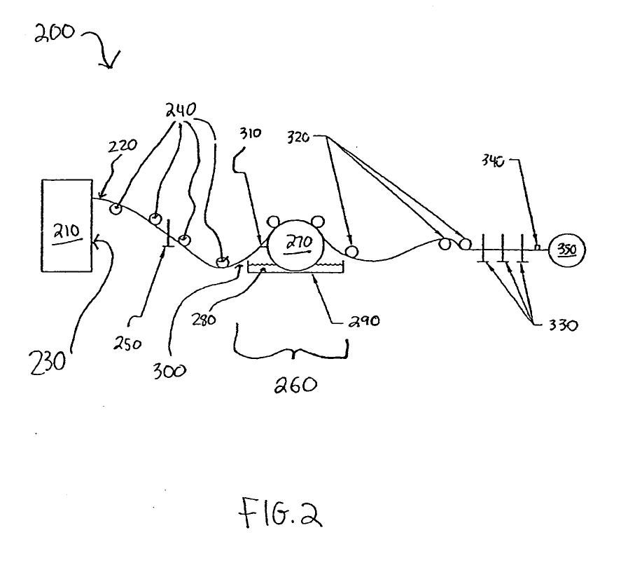

FIGS. 1A and 1B depict an exemplary composite-based rim 100 in accordance with the present invention. Incorporation of this rim 100 into a high stress and strain usage environment, such as a flywheel system, allows the flywheel system to be spun at high speeds in order to generate high levels of kinetic energy while managing the amounts/levels of strain and radial stresses generated within the rim, and, in turn, minimizing or at least reliably controlling the formation and propagation of cracks within the rim.

The rim 100 is comprised of a plurality of tailored, commingled fiber-based layers, each of which is spun or wound atop another layer via techniques such as the exemplary filament winding technique described below and depicted in FIG. 2. The rim 100 includes at least two fiber layers, and may include a plurality of layers up to, or even greater than ten. Each layer is generally comprised of a different combination of fiber(s) than the other layer(s) such that the rim exhibits increased strength and/or stiffness in each of its successive layers from its innermost layer to its outermost layer. Also, each successive layer of the rim from its innermost layer to its outermost layer has a lower density.

The exemplary rim 100 of FIGS. 1A and 1B is comprised of five layers—a first, innermost layer 110, a second layer 120, a third layer 130, a fourth layer 140, and a fifth, outermost layer 150. A gap 160 is defined within the inner layer 110 of the rim 100, and will ultimately house, for example, the shaft (not shown) and hub (not shown) of a flywheel system.

Because the rim 100 exhibits increased strength and/or stiffness in each of its successive layers, the fifth, outermost layer 150 of the rim 100 is stronger and/or stiffer than the rim's fourth layer 140, which is stronger and/or stiffer than the third layer 130 of the rim, which is stronger and/or stiffer than the rim's second layer 120, which is stronger and/or stiffer than the first, innermost layer 110 of the rim.

To that end, and in accordance with an exemplary embodiment of the present invention, the first, innermost layer 110 of the rim 100 is comprised almost entirely of a comparatively “low” strength and/or stiffness fiber. The fifth, outermost layer 150 of the rim 100 and the fourth layer 140 of the rim, however, are both comprised entirely of a fiber with comparatively “high” strength and stiffness characteristics, wherein the strength and/or the stiffness of the fiber that comprises the fifth layer is “higher” than the “high” strength and/or stiffness fiber that comprises the fourth layer.

The volume percentage of “low” strength/stiffness fiber(s) contained in each layer 110, 120, 130, 140, 150 of the rim 100 successively decreases or remains constant from the rim's first layer 110 to its fifth layer 150, while the volume percentage of “high” strength/stiffness fiber(s) contained in each layer increases or remains constant from the first layer to the fifth layer.

Preferably, the volume percentage of “low” strength/stiffness fiber(s) decreases from the first layer 110, to the second layer 120, to the third layer 130, to the fourth layer 140, and remains constant in the fourth and fifth layers 140, 150, while the volume percentage of “high” strength/stiffness fiber(s) increases from the first layer, to the second layer, to the third layer, to the fourth layer, and remains constant in the fourth and fifth layers.

More specifically, each of the second and third layers 120, 130 generally contains at least 20% by volume of both “low” and “high” strength and/or stiffness fiber materials, wherein the second layer 120 includes a greater volume percentage of “low” strength and/or stiffness fiber(s) than “high” strength and/or stiffness fiber(s), and wherein the third layer includes a greater volume percentage of “high” strength and/or stiffness fiber(s) than “low” strength and/or stiffness fiber(s).

Moreover, the “high” strength and/or stiffness fibers that partially comprise each of the second and third layers 120, 130 of the rim 100 preferably are of an identical type to the “high” strength and/or stiffness fibers that entirely comprise the fourth layer 140 of the rim. In a currently preferred embodiment of the present invention, the composition of a composite-based rim 100 is as shown below in Table I.

TABLE I

| | Volume percentage of | Volume percentage of |
|---|---|---|
| | “low” strength and/or | “high” strength and/or |
| Layer of rim | stiffness fibers | stiffness fibers |
| First, innermost layer | About 90% | about 10% |
| Second layer | About 80% | about 20% |
| Third layer | About 40% | about 60% |
| Fourth layer | about 0% | about 100% |
| Fifth, outermost layer | about 0% | about 100% |

In general, the percentage of “high” strength and/or stiffness fibers in the first, innermost layer 110 should be lower than the percentage of such fibers in the second layer 120, and the percentage of “low” strength and/or stiffness fibers in the first, innermost layer 110 should be higher than the percentage of such fibers in the second layer 120. Conversely, the percentage of “high” strength and/or stiffness fibers in each of the fourth layer 140 and the fifth, outermost layer 150 should be higher than the percentage of such fibers in the third layer 130, and the percentage of “low” strength and/or stiffness fibers in the first, innermost layer 110 should be lower than the percentage of such fibers in each of the second layer 120 and the third layer 130.

The percentage of “low” strength and/or stiffness fibers in the first layer 110 of the rim generally is in the range of about 81% to 100%, and the range of “high” strength and/or stiffness fibers in the first layer of the rim is in the range of about 19% to 0%, whereas the percentage of “low” strength and/or stiffness fibers in the fourth layer 140 of the rim generally is in the range of about 0% to 39%, and the range of “high” strength and/or stiffness fibers in the fourth layer of the rim is in the range of about 100% to 61%.

The “low” strength and/or stiffness fibers that partially comprise at least the first, second and third layers 110, 120, 130 of the rim 100 generally have a stiffness (i.e., modulus) in the range of about 8 Msi to 12 Msi, wherein a stiffness in the range of about 10 Msi to 11 Msi is currently preferred, and a stiffness of about 10.5 Msi is currently most preferred. These “low” strength and/or stiffness fibers also generally have a strength in the range of about 300 Ksi to 500 Ksi, wherein a strength in the range of about 350 Ksi to 400 Ksi is currently preferred, and a strength of about about 375 Ksi is currently most preferred.

One, some or all of the layers that include “low” strength and/or stiffness fibers may include solely one specific type of “low” strength and/or stiffness fiber, or may include a plurality of different types of such fibers, but each “low” strength and/or stiffness fiber included within each of these layers generally has strength and/or stiffness characteristics that fall within the above ranges.

Numerous suitable “low” strength and/or stiffness fibers are known; however, current exemplary “low” strength and/or stiffness fibers include, but are not limited to, E-glass fiber, which is commercially available from numerous commercial suppliers (e.g., Owens Corning of Toledo, Ohio, USA), as well as steel wire, which is also commercially available from numerous suppliers (e.g., Baekaert Corporation of Marietta, Ga., USA).

The “high” strength/stiffness fibers that partially comprise at least the first, second and third layers 110, 120, 130 of the rim 100, and that entirely comprise at least the rim's fifth layer 150 generally have a stiffness in the range of about 28 Msi to 50 Msi, and a strength generally in the range of about 700 Ksi to 1000 Ksi.

Preferably, the “high” strength and/or stiffness fibers that entirely comprise at least the fifth layer 150 of the rim 100 have a “higher” strength and/or a “higher” stiffness than the “high” strength and/or stiffness fibers that entirely or partially comprise the fourth layer 140, and that partially comprise the first, second and third layers 110, 120, 130.

The “higher” strength and/or stiffness fibers generally have a stiffness in the range of about 38 Msi to 50 Msi and generally have a strength in the range of about 800 Ksi to 1000 Ksi, wherein stiffnesses in the range of about 40 Msi to 44 Msi and strengths in the range of about 800 Ksi to 900 Ksi are currently preferred, and wherein stiffnesses in the range of about 42 Msi to 43 Msi and a strength of about 800 Ksi are currently most preferred.

The “high” strength and/or stiffness fibers generally have a stiffness in the range of about 28 Msi to 37 Msi and generally have a strength in the range of about 600 Ksi to 800 Ksi, wherein stiffnesses in the range of about 32 Msi to 35 Msi and strengths in the range of about 600 Ksi to 700 Ksi are currently preferred, and wherein stiffnesses in the range of about 33 Msi to 34 Msi and a strength of about 700 Ksi are currently most preferred.

One, some or all of the layers 110, 120, 130, 140, 150 of the rim 100 may include solely one specific type of “high” or “higher” strength and/or stiffness fibers, or may include a plurality of different types of such fibers. In an exemplary embodiment of the Table I composition, “high” strength and/or stiffness fibers are included among the composition of the first, second, third layers 110, 120, 130 of the rim 100 and entirely comprise the fourth layer 140 of the rim, while only “higher” strength and/or stiffness fibers comprise the fifth layer 150 of the rim.

Numerous suitable “high” and “higher” strength/stiffness fibers are known. Generally, both the “high” and “higher” strength/stiffness fibers are carbon-based fibers, with currently exemplary “high” strength and/or stiffness fibers including, but not being limited to, T-700 carbon fiber, and currently exemplary “higher” strength/stiffness fibers including, but not being limited to, T-800 carbon fiber. Both T-700 and T-800 carbon fibers are commercially available from numerous commercial suppliers, such as Toray Composites, Inc. of Tacoma, Wash., USA.

The compositions of the layers 110, 120, 130, 140, 150 of the rim 100 not only are selected to tailor the strengths and stiffnesses of the rim, but also to create a smooth gradient of radial stress and strain from layer to layer.

Specifically, by varying the composition (i.e., the volume percentages of “low,” “high” and “higher” strength/stiffness fibers) of the layers 110, 120, 130, 140, 150, not only are the strength and stiffnesses of those layers varied, so too are their densities and moduli. The density and modulus of each layer of the rim 100 are important factors in the equations (see below)—that govern flywheel system operation and, more particularly, that directly influence generation of radial stress and strain in the rim.
Energy=½*(rim density)*(rim volume)*(rotor radius of gyration)²*(rotational speed of rim)₂
Hoop Stress=(rim density)*(rim radius)²*(rim rotational speed)²=(strain)*(modulus)
Radial Stress−(rim density)*(rim thickness)²*(rotational speed of rim)²

By having a rim 100 comprised of five layers 110, 120, 130, 140, 150 with compositions as set forth above, the rim (during operation) is able to produce a desirably smooth gradient of radial stresses and strains from the inner layer of the rim to the outer layer of the rim.

This “smooth” gradient is caused by the variation in composition from layer to layer of the rim 100, plus the fact that the density of the “low” strength/stiffness fibers is greater than the density of the “high” and “higher” strength/stiffness fibers, while the hoop modulus of the “low” strength/stiffness fibers is less than the hoop modulus of the “high” and “higher” strength/stiffness fibers. Therefore, wherein the amount of “low” strength/stiffness fibers decreases from the innermost layer 110 to the outermost layer 150 of the rim, and the amount of “high” strength and/or stiffness fibers increases from the first layer to the fifth layer, the modulus of each layer also increases from the innermost layer to the outermost layer. In addition, the density of each layer may be reduced from the innermost layer 110 to the outermost layer 150. This allows the inner layers of the rim to radially load the rim's outer layers, thus reducing the radial stress and strain in all of the rim layers.

Because the composition of each layer does not radically change from layer to layer, the density and modulus of each layer do not radically change from one layer to the next. This, in turn, creates a “smooth” hoop stress and strain gradient, where the increase from one rim layer to the next is not a sharp increase, but rather a comparatively small, incremental increase. At the same time, the radial stress and strain of each layer remains bounded from the inner layer 110 to the outer layer 150.

According to the above equations, further control over the radial stress and strain gradient in the rim can be achieved by modifying the radius of one or more of the layers 110, 120, 130, 140, 150 of the rim 100.

Each layer 110, 120, 130, 140, 150 of the rim 100, however, has a predetermined, non-modified diameter/radius, as shown in FIG. 1B. Generally, the gap 160 has a diameter, D_{G}, of about 12.5 inches, and, thus, a radius of about 6.25 inches. The diameter, D₁, of the rim 100 at its first layer 110 is about 13.5 inches; the diameter, D₂, of the rim at its second layer 120 is about 15.5 inches; the diameter, D₃, of the rim at its third layer 130 is about 17.6 inches, the diameter, D₄, of the rim at its fourth layer 140 is about 19.3 inches; and the diameter, D₅, of the rim at its fifth layer is about 21.1 inches. Therefore, the currently preferred, non-modified radii of the rim 100 at its first, second, third, fourth and fifth layers 110, 120, 130, 140, 150 are, respectively, about 6.75 inches, 7.75 inches, 8.8 inches, 9.65 inches, and 10.05 inches.

These radii are currently preferred based on the composition of the layers 110, 120, 130, 140, 150 of the rim 100. It should be understood, however, that one, some or all of the layers 110, 120, 130, 140, 150 of the rim 100 may have radii/diameters that are greater or less than these currently preferred diameters/radii for various reasons (e.g., in order to allow/facilitate modification or variation of the radial stress and strain gradients of the rim from layer to layer) without departing from the scope of this invention.

Conventional composite-based rims do not achieve this type of smooth gradient due to having thicker layers of fibers, wherein the fibers composition is uniform from layer to layer. If, for example, a conventional flywheel system rim is comprised of separate layers that are each made of the same material, there will be no change in radial stress or strain (i.e., no gradient) from layer to layer. If, instead, a conventional flywheel system rim is comprised of separate layers of different material, but wherein each layer comprises 100% of a particular material, then the difference in radial stress and strain from layer to layer will be highly pronounced, thus resulting in a sharp, pronounced radial stress and strain gradient.

Therefore, in contrast to conventional composite-based rims, a rim 100 in accordance-with the present invention exhibits a gradual increase in strength and stiffness from its first layer 110 to its fifth layer, and bounds the radial stress and strain from its first to fifth layers. This results in a rim 100 that is much more failure resistant than conventional composite-based rims, as shown in the following comparative examples.

### COMPARATIVE EXAMPLES

Two five layer composite-based rims of the present invention were tested for comparison purposes against three conventional two-layer rims, wherein each layer of the conventional rims was entirely comprised of T-700 carbon-fibers, and wherein the two layers of the conventional rims were not commingled.

Also, all five of the rims tested had identical overall dimensions (thus indicating that the radial thickness of each layer of the two-layer rim was 2.5 times greater than the radial thickness of the five-layer rim of the present invention), and were incorporated into otherwise identical flywheel systems for testing purposes.

One or more cracks were observed to have formed in each of the three conventional two-layer rims that were tested after less than fifteen hours of continuous operation of the flywheel system at rotational speeds of less than 20.5 KPM. Specifically, crack formation was observed in the first conventional two-layer rim tested after 14.17 hours of flywheel system operation at 20.3 KPM, in the second conventional two-layer rim tested after hours of flywheel system operation at 15 KPM, and in the third conventional two-layer rim tested after 3.23 hours of flywheel system operation at 18.4 KPM. Thus, on average, crack formation was observed in these conventional two-layer rims after only 7.47 hours of flywheel system operation at 17.9 KPM.

Two five-layer rims 100 having characteristics in accordance with the present invention, and having overall dimensions identical to the three conventional two-layer rims tested were incorporated into otherwise identical flywheel systems to the flywheel systems into which the conventional three two-layer rims were incorporated for testing. Crack formation was not observed in either the first five-layer rim after 24 hours of flywheel system operation at 23.5 KPM, or the second five-layer rim after 1000 hours of flywheel system operation at 22.5 KPM.

According to these results, five-layer rims 100 in accordance with the present invention are safer than otherwise identically dimensioned conventional composite-based rims, even if incorporated into otherwise identical flywheel systems that were operated at much higher rotational speeds for much longer durations as compared to the flywheel systems into which the conventional two-layer rims were incorporated. Moreover, this added rotational speed and duration of operation of a flywheel system that incorporates a five-layer rim 100 of the present invention will translate into the generation of much higher amounts of kinetic energy as compared to a flywheel system that incorporates one of the conventional two-layer rims that was tested.

Additionally, even though these tests indicate that five-layer rims allow for safe operation of a flywheel system without the formation of cracks in the rim, the design of a rim in accordance with the present invention is such that even if a crack was to form in the rim, the crack would most likely form in a predetermined layer of the rim, and would not propagate enough to cause failure of the rim prior to the crack being detected by safety equipment/monitors.

As noted above, the strength and stiffness to density ratio of each layer of the rim increases from the first layer 110 of the rim 100 to the fifth layer 150 of the rim, while the radial stress and strain decreases from the first layer to the fifth layer. Thus, in the unlikely event that a crack does form in a five-layer rim 100 of the present invention, it will most likely form in the rim's first, innermost layer, which is the comparatively weakest layer of the rim, and which is the layer that encounters the highest hoop stresses and strains in relation to its capacity.

And if/when a crack does form in the first layer, the crack will be inhibited from propagating into the second layer because each layer has commingled fibers, and because the second layer is stronger than the first layer and, thus, is more resistant to crack formation/propagation. And if a crack does happen to propagate into the second layer of the rim, it will be inhibited from propagating into the stronger third layer, and so on. The fourth and fifth layers of the rim are especially highly resistant to crack formation/propagation because they are comprised entirely of one or more “high” strength and/or stiffness fibers.

Therefore, there will be a significant delay between the onset of a crack in the first, innermost layer of the rim and the propagation of that crack through the entire radius of the rim. This delay will be more than long enough to allow flywheel system safety equipment/monitors to detect that a crack has formed, to trigger a cessation of power to the flywheel system, and for the flywheel system to safely decelerate and spin to a halt prior to rim failure/burst.

The flywheel system is able to detect the onset of a crack because such an event will cause an upset and/or imbalance condition in the spinning flywheel system, wherein such a condition will be sensed by level controls (not shown) or other equipment incorporated into the flywheel system. Upon sensing this condition, the level controls would immediately cause discontinuation of the supply of power to the flywheel, thus causing the flywheel to gradually decelerate to a stop.

Therefore, the five-layer rim compositions of the present invention represent a design philosophy/methodology that not only deters crack formation in the rim by controlling the radial stresses encountered within the rim to manageable levels. Further, such a design philosophy/methodology, by virtue of the tailored compositions of the layers of the rim, causes cracks (if any are formed at all) to be initially formed in the first layer, and severely inhibits the ability of such cracks to propagate into the second, third, and especially fourth and fifth layers of the rim.

This, in turn, allows the flywheel system to be confidently operated at high speeds up to and above 22.5 KPM without fear of adverse effects (i.e., rim failure/burst), thus allowing for the system to beneficially generate a large amount of kinetic energy.

Referring now to FIG. 2, an apparatus 200 is shown for manufacturing a composite rim via a filament winding technique in accordance with the present invention. The apparatus 200 includes a combined fiber storage/dispensing device 210 (e.g., a creel), which is equipped with at least one holder/rack (not shown), for holding a unit (e.g., a spool) of fiber material, and for dispensing tows of fiber from one or more of the spools as is generally known in the art.

The number of racks/holders present in the device is greater than or, as is currently preferred, equal to the number of tows that will be combined by the apparatus to form each separate layer of the rim. Ten racks are preferable for practicing the present invention, in which each layer of the rim 100 (whether the layer is comprised of solely one type of fiber, or of a combination of more than one fiber) generally includes ten tows, each of which can be supplied from one of the holders. It is understood, however, that the number of holders is not crucial, however, as the process can be carried out by one of ordinary skill in the art without undue experimentation with greater than or fewer than ten racks/holders.

Fiber is fed from each rack/holder and layered atop each other in predetermined tow arrangements in order to commingle the tows in each rim layer. This preliminarily-formed layer 220 emerges from an output end 230 of the device 210 and is directed through one or more physical adjustment devices (e.g., one ore more rollers 240 and/or one or more combs 250) effective to align the fibers within the preliminarily formed layer, to control the tension of the layer, and/or to provide the layer with a predetermined bandwidth (i.e., thickness).

The layer 220 then enters a resin treatment area 260 of the apparatus 200 where a spinning drum 270 is continuously being impregnated with wet resin 280 from a holding area 290 (e.g., a resin bath). The wet resin 280 can be any epoxy suitable for filament winding, or any suitable thermoset or thermoplastic resin system. It is currently preferred to select the resin such that when it cures it has a minimum tensile strength of about 4 Ksi.

As the layer 220 advances through the resin treatment area 260, the resin-coated drum 270 spins in the direction of advancement of the layer, thus causing the bottom-facing side 300 of the fiber layer to be coated with wet resin 280. Optionally, the resin treatment area 260 may also include an implement (e.g., a knife 310) to control the thickness of the resin mixture 280 being coated upon the layer 220.

It should be understood that the resin 280 can be introduced to the layer 220 via different techniques than that which is described above and depicted in FIG. 2. By way of non-limiting example, the layer 220 can be directed into the resin holding area 290, thus causing it to be coated with resin. Other alternative techniques are generally known in the art.

The wet layer 220 is then directed through one or more additional alignment/tensioning devices (e.g., one or more rollers 320 and/or one or more combs 330) to produce a uniform, wet layer of fiber material of a predetermined bandwidth. Generally, the bandwidth of each layer is in the range of about 1.0 inch to 1.3 inch, wherein a currently preferred bandwidth being in the range of about 1.05 inch to about 1.15 inch.

The layer 220 is then fed through a guiding device 340 (e.g., an eyelet) and onto a shape-instilling shell 350 (e.g., a metal-based mandrel), which is rotating in the direction of advancement of the layer. The layer 220 is caused to be wound onto the rim shell/base 350 to form one of the layers of the multiple-layer rim 100 of the flywheel system.

Once all the layers of the rim 100 are in place, the shell 350 is cured (e.g., via an oven), thus causing the resin 280 on each layer to dry, and causing the mandrel 350 to outwardly expand. Thereafter, the mandrel 350 is removed from the oven and allowed to cool. During cooling, the mandrel 350 (but not the rim) shrinks to its original dimensions, thus facilitating removal of the rim 100 therefrom. Optionally, objects known in the art (e.g., peel plies and/or bleeder cloths) may be utilized to facilitate/expedite the removal of the rim 100 from the shell 350 following curing.

In an exemplary embodiment of the present invention, ten tows of fiber comprise each layer of the rim 100, wherein the selection of the specific tows for inclusion in each layer is made based on the desired volume percentage composition of that particular layer. Because the fourth layer 140 of the rim 100 is comprised of 100% “high” strength and stiffness fibers, that layer is generally formed of ten commingled tows of “high” strength and/or stiffness fibers, while because the fifth layer 150 of the rim is comprised of 100% “higher” strength and/or stiffness fibers, that layer is generally formed of ten commingled tows of “higher” strength and/or stiffness fibers.

The remaining layers 110, 120, 130 of the rim 100 are comprised of “low” strength and/or stiffness and “high” strength and/or stiffness fibers, and are formed, pro rata, from commingled tows of those types of fibers. For example, the first layer 110 of the rim 100 is comprised of about 90% “low” strength and/or stiffness fibers and about 10% “high” strength and/or stiffness fibers and, therefore, is generally formed from nine tows of “low” strength and/or stiffness fibers and one tow of “high” strength and/or stiffness fibers. The second layer 120 of the rim 100 is comprised of about 80% “low” strength and/or stiffness fibers and about 20% “high” strength and/or stiffness fibers and, therefore, is generally formed from eight tows of “low” strength and/or stiffness fibers and two tows of “high” strength and/or stiffness fibers. The third layer 120 of the rim 100 is comprised of about 40% “low” strength and/or stiffness fibers and about 60% “high” strength and/or stiffness fibers and, therefore, is generally formed from four tows of “low” strength and/or stiffness fibers and six tows of “high” strength and/or stiffness fibers.

The layers of the rim that include commingled fiber tows can have various tow placement orders. For example, in the first layer 110 of the rim 100 it is currently preferred that the one “high” strength and/or stiffness tow be either the first or the tenth tow of the layer, while in the second layer 120 of the rim, it is currently preferred that at least one of the two “high” strength and/or stiffness tows be either the first or tenth tow, but that both “high” strength and/or stiffness tows not be placed adjacent each other. In the third layer 130 of the rim 100, it is currently preferred that none of the “low” strength tows be placed adjacent each other.

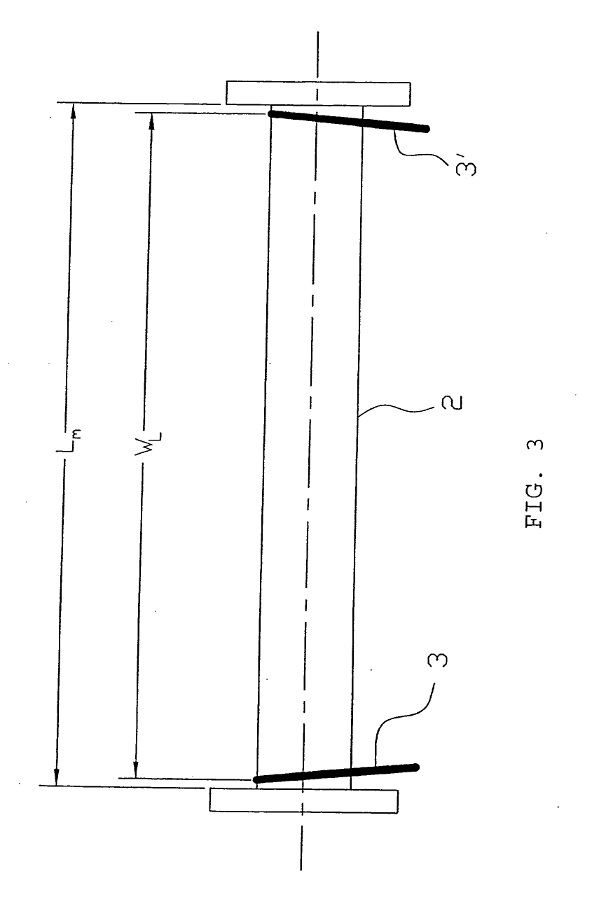

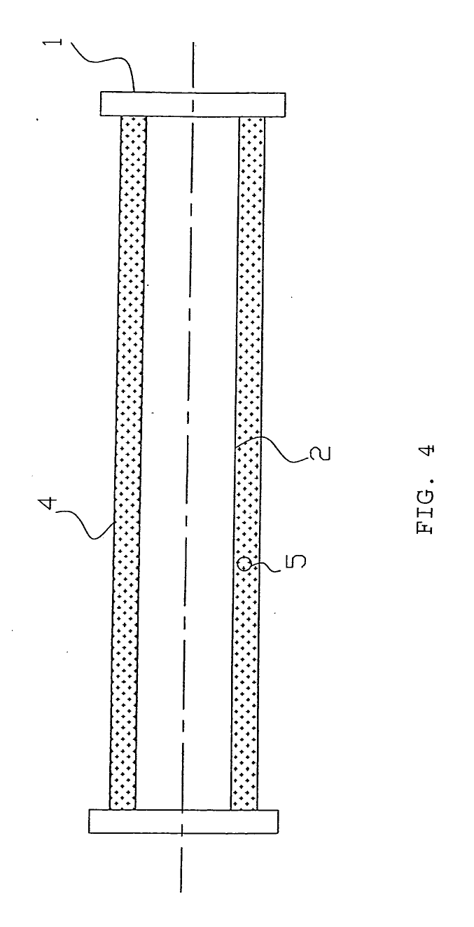

Further aspects and embodiments of the present invention are depicted in FIGS. 3-7. In FIG. 3, a mandrel 2 is shown for winding resin-impregnated tows in a fiber band 3 to produce an elongated annular composite “log” 4, shown in FIG. 4. The “log” 4 can comprise a one or more annular flywheel rims and can be cut into numerous shorter annular flywheel rims. The tows can be wound in accordance with a winding technique known in the art, such as a winding technique described and/or depicted in U.S. Pat. No. 4,370,899 to Swartout, or in U.S. Pat. No. 5,628,232 to Bosley et al., or in U.S. Pat. No. 5,665,192 to Wolki et al.

The mandrel 2 illustrated has two end flanges 1, which help confine the resin-impregnated fiber tows on the ends of the mandrel 2 as the fiber band 3 is being wound. The length (Lₘ) of the mandrel 2 is the full length between the facing surfaces of the two flanges 1.

The fiber band 3 is made up of a number of fiber tows: one example, described below, has twenty fiber tows in the fiber band. The fiber band is be made up of a mixture of carbon fiber tows and glass fiber tows which are impregnated with wet resin and wound onto the mandrel by a winding apparatus which traverses back and forth lengthwise of the mandrel as the mandrel turns and winds the fiber band in layers onto the mandrel. A number of such layers are laid down in a zone, in which the ratio of glass fiber tows to carbon fiber tows is constant in each layer.

The ratio of glass fiber tows to carbon fiber tows is incrementally increased in the next zone or layer of multiple layers to produce a zone with a greater proportion of carbon fiber tows. The proportion of carbon fiber tows can be further increased in each subsequent zone until the last zone in which all the tows may be all carbon fiber tows. For example, a composite flywheel made in accordance with this approach could be made in 5 contiguous zones from inside to radially outside, as follows: 1. 10% CF, 90% GF; 2. 20% CF, 80% GF; 3. 50% CF, 50% GF; 5. 100% CF (as used herein, “GF” is glass fiber and “CF” is carbon fiber).

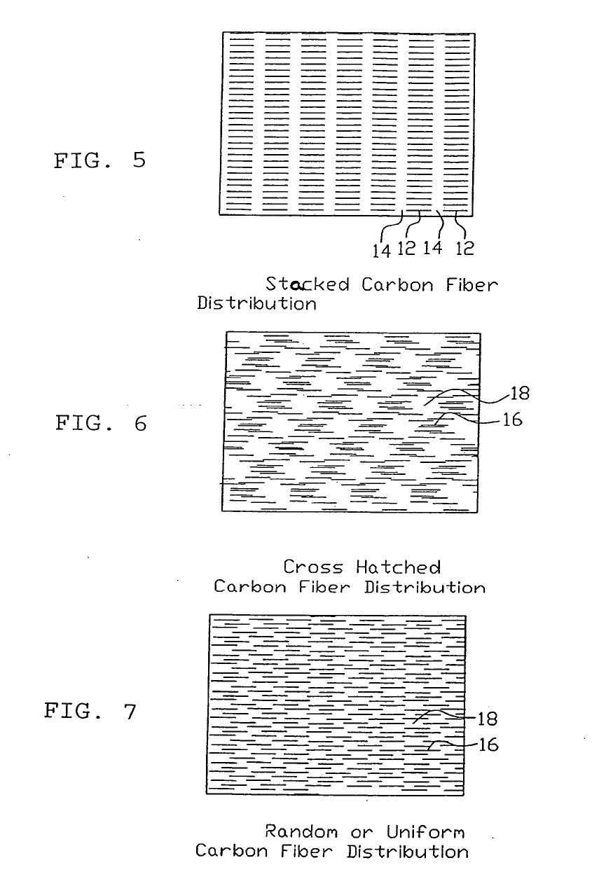

When the fiber band 3 is wound onto the mandrel 2, an undesirable distribution of glass and carbon fiber tows, can occur, as shown in FIG. 5, wherein the carbon fiber tows are radially stacked in aligned regions or columns 12, separated by regions or columns 14 of radially stacked glass fiber tows, all in an epoxy matrix. The forces action on the flywheel rim during high speed rotation can be substantial and the different modulus of elasticity of the glass and carbon fibers in adjacent regions can result in shear forces between the adjacent regions. These shear forces have never resulted in any known failures or damage to any flywheel rim, but it is thought best to avoid the possibility by winding the fiber tows on the mandrel in such a way as to distribute the carbon fiber tows more uniformly amongst the glass fiber tows. According to the present invention, the fiber band is wound onto the mandrel in such a way such that the carbon fiber tows lie in a macroscopically uniform distribution in each zone.

In accordance with the present invention, it has been found that that the foregoing can be accomplished by controlling the correlation between lead rate of the fiber band as it is wound onto the mandrel per mandrel revolution and the winding length. Specifically, it has been found that various lay up patterns can be obtained cyclically by changing the winding length W_{L} while holding constant other parameters such as lead rate L_{R} per revolution of mandrel, mandrel diameter, fiber band width and position of carbon fiber tow(s) within a fiber band of glass fiber tows.

The winding length W_{L} is defined as the traverse distance of fiber band center line between one end of the mandrel 2 and the other end during winding, as shown in FIG. 4. The lead rate L_{R} is the longitudinal distance between adjacent turns of a band of fiber, measured center-to-center, as it is wound on the mandrel.

The lead rate L_{R} is often less than the fiber band width since the band are usually made to overlap. To make a good composite rim, the value of L_{R} is no greater than the fiber band width. This is the most practical way to make a composite rim strong enough in the hoop direction by laying up fiber axis as close as possible to hoop direction of the rim.

In the case of FIGS. 3-5, the winding parameters are as indicated in Table II below.

TABLE II

| FIG. | Winding Length W_{L} (inch) |
|---|---|
| 3 | 165.5 |
| 3 | 166.0 |
| 4 | 165.8 |
| 4 | 165.7 |
| 5 | 165.9 |
| 5 | 165.6 |

Other parameters are constant regardless of winding parameters. Such parameters are indicated in Table III below:

| Parameter | Value/Measurement |
|---|---|
| Lead Rate (L_{R}) | 1.5 inch/revolution |
| Band Width | 3 inches |
| Number of total Carbon Fibers in | 2 Carbon Fiber tows out of 20 |
| tows | total tows |
| Number of total Glass Fibers in tows | 18 Glass Fiber tows out of 20 total |
| | tows |
| Mandrel Diameter | 12.45 inches |

In an exemplary embodiment according to these parameters, the position of the two carbon fiber tows in the fiber band correspond to the #1 position and the #15 position in a fiber band as shown below, wherein the remaining positions are occupied by glass fiber tows:

1 2 3 4 5 6 7 8 9 10 11 12 13 14 15 16 17 18 19 20

Other possible carbon fiber positions according to these parameters include, but are not limited to (a) position #6 and position #11, and (b) position #1 and position #16.

The undesirable stacked fiber pattern of FIG. 5 can be avoided, and the desirable random or uniform carbon fiber tow distribution of FIG. 7 can be attained by satisfying the following equations:
W_{L}=(N+B/A)*L_{R}. and W_{L}+L_{R}<L_{M} and M*L_{R}=N*S_{P}
wherein:
N=Maximum integer obtained when W_{L} is divided by L_{R}
A=integer larger than B
B=integer smaller than A
B/A≠1, ½, ⅓, ¼
W_{L}=Winding Length (inch)
L_{R}=Lead Rate (inch)
L_{M}=Distance between inner faces of two mandrel flanges (inch)
M=integer≧2
N=integer≧2
S_{P}=fiber space amongst other fibers (inch)

Wet filament winding, where a thermoset resin such as epoxy is impregnated into raw fibers during the winding operation, is a currently preferred fabrication method for a composite rim. The fibers are arranged in tows and the macroscopic distribution of the carbon fiber tows is preferably uniform or random throughout the rim. The carbon fibers and glass fibers are concentrated in these tows, so the distribution of the actual fibers is not uniform or random, but the distribution of the tows is uniform or random. This is the meaning of “macroscopic” uniform or random distribution.

Although one or more currently preferred embodiments of the invention has/have been described using specific terms, such description is for illustrative purposes only, and it is to be understood that changes and variations may be made without departing from the spirit or scope of the following claims.

1. A hybrid composite flywheel rim comprising: at least two different types of fibers impregnated with a thermosetting resin and wound in an annulus on a mandrel, said two different fibers having different elastic moduli; one of said two fiber types being randomly distributed amongst the other fiber macroscopically.

2. The hybrid composite flywheel rim of claim 1, further comprising a plurality of layers, at least one layer of said plurality of layers being composed of at least two different types of fibers impregnated with a thermosetting resin, said two different fibers having different elastic moduli; one of said two fiber types being randomly distributed amongst the other fiber macroscopically in said at least one layer.

3. The hybrid composite flywheel rim of claim 2, wherein at least one of the strength and stiffness of each layer increases in each layer from an innermost layer of the rim to an outermost layer of the rim.

4. The hybrid composite rim of claim 2, wherein the elastic moduli of the two different elastic moduli differ by at least 5 Msi.

5. The hybrid composite flywheel rim of claim 2, wherein at least one layer of said plurality of layers being formed entirely from one of a low modulus fiber and a high modulus fiber, and another layer of said plurality of layers being formed from both the low modulus fiber and the high modulus fiber.

6. A hybrid composite flywheel rim as defined claim 1, wherein the following equations are satisfied:
W_{L}=(N+B/A)*L_{R}. and W_{L}+L_{R}<L_{M} and M*L_{R}=N*S_{P}
and wherein:
N=Maximum integer obtained when W_{L} is divided by L_{R}
A=integer larger than B
B=integer smaller than A
B/A≠1, ½, ⅓, ¼
W_{L}=Winding Length (inch)
L_{R}=Lead Rate (inch)
L_{M}=Distance between inner faces of two mandrel flanges (inch)
M=integer≧2
N=integer≧2
S_{P}=fiber space amongst other fibers (inch)

7. The hybrid composite flywheel rim of claim 1, wherein said one of said two fiber types is distributed amongst the other fiber in a cross hatch pattern macroscopically.

8. The hybrid composite flywheel rim of claim 7, further comprising a plurality of layers, at least one layer of said plurality of layers being composed of at least two different types of fibers impregnated with a thermosetting resin, said two different fibers having different elastic moduli; one of said two fiber types being randomly distributed amongst the other fiber macroscopically in said at least one layer.

9. The hybrid composite flywheel rim of claim 8, wherein at least one of the strength and stiffness of each layer increases in each layer from an innermost layer of the rim to an outermost layer of the rim.

10. The hybrid composite rim of claim 8, wherein the elastic moduli of the two different elastic moduli differ by at least 5 Msi.

11. The hybrid composite flywheel rim of claim 8, wherein at least one layer of said plurality of layers being formed entirely from one of a low modulus fiber and a high modulus fiber, and another layer of said plurality of layers being formed from both the low modulus fiber and the high modulus fiber.

12. A hybrid composite flywheel rim as defined claim 7, wherein the following equations are satisfied:
W_{L}=(N+B/A)*L_{R}. and W_{L}+L_{R}<L_{M} and M*L_{R}=N*S_{P}
and wherein:
N=Maximum integer obtained when W_{L} is divided by L_{R}
A=integer larger than B
B=integer smaller than A
B/A≠1, ½, ½, ¼
W_{L}=Winding Length (inch)
L_{R}=Lead Rate (inch)
L_{M}=Distance between inner faces of two mandrel flanges (inch)
M=integer≧2
N=integer≧2
S_{P}=fiber space amongst other fibers (inch)

13. A hybrid composite flywheel rim, comprising: fibers having different elastic moduli, said fibers including carbon fiber, glass fiber, said fibers fixed in a matrix of thermosetting resin; said carbon fiber is distributed amongst the other fiber in a cross hatch pattern macroscopically.

14. A hybrid composite flywheel rim as defined claim 13, wherein the following equations are satisfied:
W_{L}=(N+B/A)*L_{R}. and W_{L}+L_{R}<L_{M} and M*L_{R}=N*S_{P}
and wherein:
N=Maximum integer obtained when W_{L} is divided by L_{R}
A=integer larger than B
B=integer smaller than A
B/A≠1, ½, ⅓, ¼
W_{L}=Winding Length (inch)
L_{R}=Lead Rate (inch)
L_{M}=Distance between inner faces of two mandrel flanges (inch)
M=integer≧2
N=integer≧2
S_{P}=fiber space amongst other fibers (inch)

15. The hybrid composite flywheel rim of claim 13, further comprising a plurality of layers, at least one layer of said plurality of layers being composed of said fibers having different elastic moduli and wherein said carbon fiber is randomly distributed amongst the other fiber type macroscopically in said at least one layer.

16. The hybrid composite flywheel rim of claim 15, wherein at least one of the strength and stiffness of each layer increases in each layer from an innermost layer of the rim to an outermost layer of the rim.

17. The hybrid composite rim of claim 15, wherein the elastic moduli of said fibers having different elastic moduli differ by at least 5 Msi.

18. A composite flywheel rim, comprising:
an annular structure having a plurality of zones, each with multiple fiber layers in a resin matrix, each said fiber layer having a mixture of carbon fiber tows and glass fiber tows at a ratio of tows that is constant in each layer of any single zone, and said ratio incrementally increases zone-by-zone radially toward outside zones of said rim; and
wherein said carbon fiber tows lie in a macroscopically uniform distribution in each zone by controlling the correlation between lead rate of the fiber band as it is wound onto the mandrel per mandrel revolution and the winding length.

19. The hybrid composite flywheel rim of claim 1, wherein the thermosetting resin is an epoxy resin.

20. The hybrid composite flywheel rim of claim 1, wherein the thermosetting resin is an epoxy resin.
